(19) United States
(12) Patent Application Publication
(10) Pub. No.: US 2015/0161913 A1
(43) Pub. Date: Jun. 11, 2015

(54) METHOD, COMPUTER-READABLE STORAGE DEVICE AND APPARATUS FOR PROVIDING A RECOMMENDATION IN A VEHICLE

(71) Applicants: AT&T Mobility II LLC, Atlanta, GA (US); AT&T Intellectual Property I, L.P., Atlanta, GA (US)

(72) Inventors: Brian Dominguez, Atlanta, GA (US); Michael S. Denny, Sharpsburg, GA (US); Brian Greaves, Atlanta, GA (US); Ricardo Niedermeyer, Smyrna, GA (US); Steven Neil Tischer, Atlanta, GA (US)

(73) Assignees: AT&T Mobility II LLC, Atlanta, GA (US); AT&T Intellectual Property I, L.P., Atlanta, GA (US)

(21) Appl. No.: 14/102,191

(22) Filed: Dec. 10, 2013

(51) Int. Cl. G09B 19/16

(52) U.S. Cl. CPC G09B 19/167

(57) ABSTRACT

A method, computer-readable storage device and apparatus for providing a recommendation in a vehicle are disclosed. For example, the method monitors a plurality of scoring categories of a driver while the vehicle is operating in a training mode, calculates a score for the driver based on the monitoring of the plurality of scoring categories, and provides the recommendation to the driver based upon the monitoring of the plurality of scoring categories.

### BACKGROUND

Currently, individuals learn how to drive from other individuals, such as driving instructors or driving schools. For example, a student driver may learn to drive with a driving instructor as the driving instructor is providing feedback and/or instructions to the student driver inside the vehicle.

As automobiles evolve (e.g., new vehicles are produced or existing vehicles are updated via over-the-air updates with new features), the automobile may include more features that can be distracting to the user, e.g., multimedia features such as music features and video features, and communication features like messaging and telephony communication. In addition, drivers are often not required to re-test for competence once the drivers have obtained their driver's license. As a driver ages, the driver may forget to maintain or observe proper driving techniques or rules. In addition, the driver's driving habits may change over time and may lead to driving behaviors that are inconsistent with proper driving standard.

### SUMMARY

In one embodiment, the present disclosure provides a method, computer readable storage device and apparatus for providing a recommendation in a vehicle. In one embodiment, the method monitors a plurality of scoring categories of a driver while the vehicle is operating in a training mode, calculates a score for the driver based on the monitoring of the plurality of scoring categories, and provides the recommendation to the driver based upon the monitoring of the plurality of scoring categories.

### BRIEF DESCRIPTION OF THE DRAWINGS

The essence of the present disclosure can be readily understood by considering the following detailed description in conjunction with the accompanying drawings, in which:

FIG. 1 illustrates one example of a vehicle of the present disclosure;

FIG. 2 illustrates an example flowchart of a method for providing a recommendation for assisting the training of a driver in a vehicle; and

FIG. 3 illustrates a high-level block diagram of a general-purpose computer suitable for use in performing the functions described herein.

To facilitate understanding, identical reference numerals have been used, where possible, to designate identical elements that are common to the figures.

### DETAILED DESCRIPTION

The present disclosure relates generally to next generation user interfaces in vehicles and, more particularly, to a method, computer-readable storage device and apparatus for providing a recommendation to assist in the training of a driver in a vehicle. As discussed above, individuals typically learn how to drive from other individuals, such as driving instructors or driving schools. For example, a student driver may learn to drive with a driving instructor as the driving instructor is providing feedback and/or instructions to the student driver inside the vehicle. Furthermore, older drivers may also forget driving rules or maneuvers as such older drivers progress in age. Such older drivers may also take a refresher driving course with driving instructors.

However, as technology in vehicles continues to advance, more sensors and computer interfaces are being added to vehicles. These sensors and computer interfaces may be exploited to track an individual's driving habits and store such information for later use.

One embodiment of the present disclosure leverages the next generation of interfaces in vehicles to train drivers in a training mode of the vehicle. The present disclosure may be used to train new drivers or provide “refresher” training for older drivers.

For example, various sensors in the vehicle are used to monitor a driver's actions, the way a driver operates the vehicle and a driver's movements. The monitoring may be used to track and calculate a score for the driver. The score may be related to various categories and action items to eventually provide feedback and/or recommendations to train the driver. In one embodiment, if a driver's action requires immediate feedback, the vehicle may provide immediate feedback in a recommendation provided via a graphical user interface (e.g., providing a video cue or an audio cue) or a haptic feedback.

In one embodiment, the vehicle may perform the monitoring during a training mode. In the training mode, one or more features of the vehicle can be disabled to prevent the driver from being distracted. For example, “infotainment” features of the vehicle or various cabin controls of the vehicle may be disabled. The “infotainment” features may include, for example, Internet access, searching, weather information, news information, point of interest information, radio, compact disc players, DVD players, MP3 players, input/output devices for external media players, and the like. The cabin controls may include, for example, air condition controls, heat controls, defrosting controls, wiper controls, and the like.

In one embodiment, the training mode may be triggered or engaged by a driver entering a code or a password. The training mode may also be exited or disengaged by the driver re-entering the code or the password. In another embodiment, the training mode may be entered based upon an identity of a driver, e.g., when the system detects that a particular driver is operating the vehicle, the system will activate the training mode. For example, driver recognition may be used by the camera sensors inside of the vehicle (e.g., the system recognizes a particular driver based on face recognition matching), a fob device programmed specifically for a driver (e.g., the system detects the presence of a key fob device associated with a particular driver), and the like.

In one embodiment, after a driver achieves a predefined score to exit the training mode, the driver may use the training mode again periodically to maintain his or her driving ability. For example, younger drivers tend to be less experienced and may require continuous training and monitoring even after younger drivers have passed their minimum pre-requisite to obtain a license. Thus, the training mode could be used to periodically monitor and score licensed drivers between a various age group (e.g., between 16-21, after 55, and so on).

In one embodiment, the scoring and training mode can be used to provide information to a third party entity. For example, the scores of the driver can be stored and transmitted to an automobile insurance company. In one embodiment, the information may include a test sequence that was used, videos or photographs captured by one of the sensors, and the like that may show what contributed to the score.

The automobile insurance company may use the driver's score to determine an insurance premium or rate for the driver. For example, the higher the driver's score, the lower the insurance premium will be set. Alternatively, in one embodiment the automobile insurance company may provide a periodic reward, e.g., a monthly credit, that can be accumulated over a policy period, e.g., a yearly period, where good driving behavior (consistent high monthly scores) will be provided with a financial credit at the end of the policy period.

In one embodiment, the automobile insurance company may be allowed to control when the training mode is entered on the car. Thus, the automobile insurance company may be able to periodically test the driver's skills and receive the scores of the results.

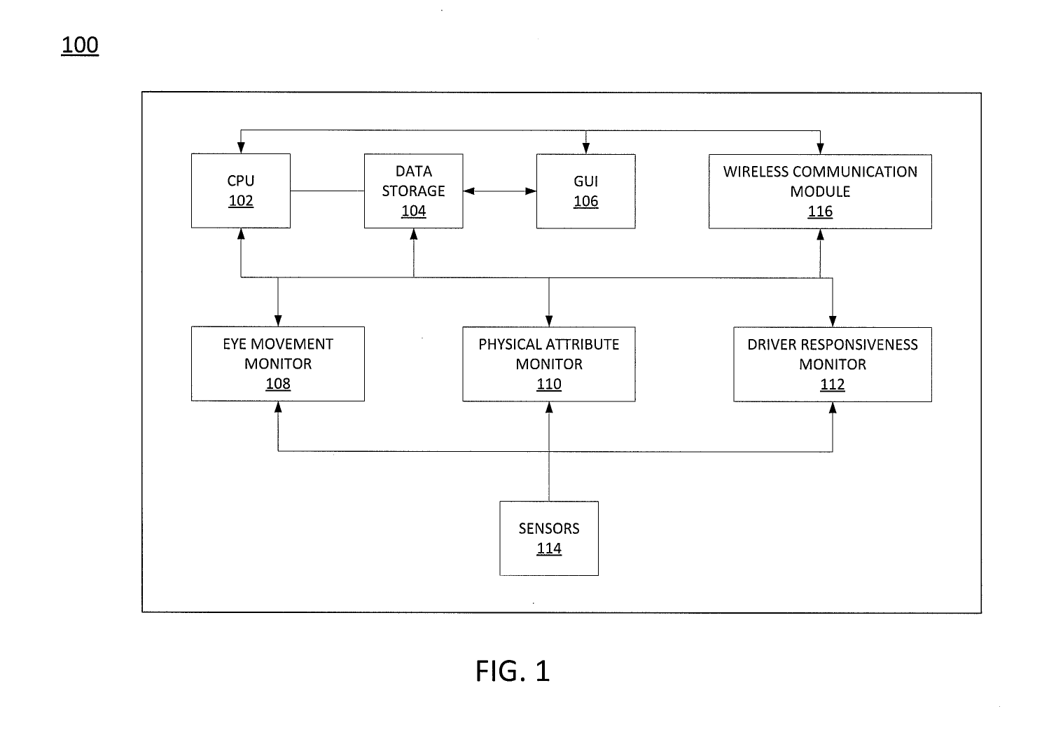

FIG. 1 illustrates a block diagram depicting one example of a vehicle 100 of the present disclosure. The vehicle 100 may be a car, a truck, a bus, a semi-truck, a motorcycle, and the like. In other words, the vehicle 100 may be any type of automobiles that require a driver to be trained (e.g., to obtain a license or permit for operation of the automobiles).

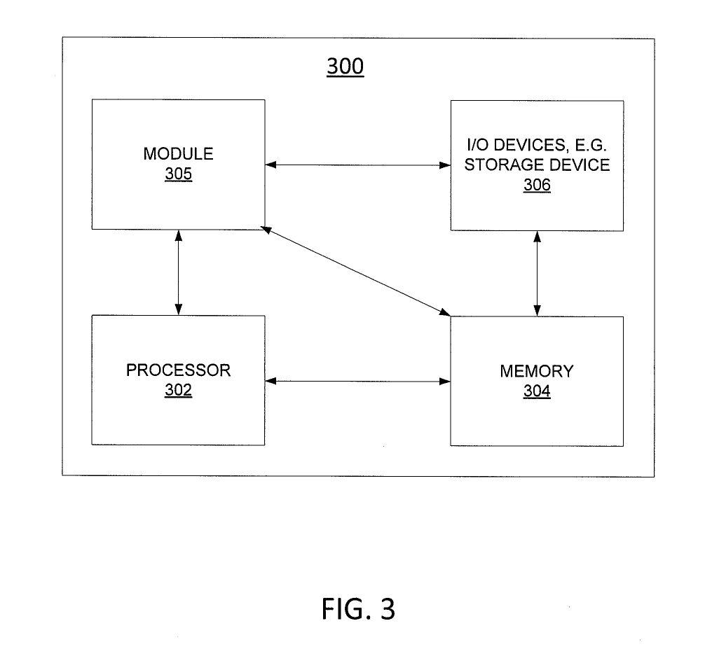

In one embodiment, the vehicle 100 may include a computer processing unit (CPU) or any type of hardware processor or controller 102 and a data storage unit 104. The CPU 102 may perform the various operations and/or functions as described herein. For example, the CPU 102 may analyze the information collected by the sensors (e.g., weight shifting, seat position, reaction time, eye movement, and other movements discussed below), perform score calculations based upon the monitoring, determine which recommendations need to be made to the driver and when the recommendations should be made, and the like. In one embodiment, the CPU 102 may be deployed in the vehicle 100 as a general purpose computer described in FIG. 3 below.

In one embodiment, the data storage unit 104 may include a computer-readable storage device for storing driver information and identities, storing the categories and action items for each category that is monitored for a driver, storing a driver's score to enable retrieval of the driver's score, storing a password or a pre-defined code to enable a training mode, and the like. In one embodiment, the data storage unit 104 may also store a score level and progress of the driver to determine which one of one or more features of the vehicles should be disabled or enabled.

In one embodiment, the vehicle 100 may include a graphical user interface (GUI) 106. The GUI 106 may be a touch screen. The GUI 106 may be used to display information to a user and receive information from a user. The GUI 106 may receive information regarding a driver's identity, information regarding whether the vehicle should enter or exit a training mode, transmit scoring information to a third party entity, and the like. The GUI 106 may also display or provide information (e.g., via a voice or graphically) regarding recommendations to the driver, feedback to the driver, and the like.

In one embodiment, the vehicle 100 may also include a wireless communication module 116. The wireless communication module 116 may be used to provide Internet access to the vehicle and wireless communications (e.g., texting, emailing, messaging, data transmission and the like) that can be used to transmit the driver's score to a third party entity.

In one embodiment, the vehicle 100 may also include one or more various modules for monitoring various categories via one or more sensors 114. In one embodiment, the modules may include an eye movement monitoring module 108, a physical attribute monitoring module 110 and a driver responsiveness monitoring module 112.

In one embodiment, the eye movement monitoring module 108 may monitor a driving category and action items related to eye movement of a driver. For example, one of the sensors may be a video camera in the cabin of the vehicle 100. The video camera may be used to monitor the eye movement of the driver. In one embodiment, the action items within the eye movement category may include, for example, whether the eyes are closed longer than a pre-defined period (e.g., 10 seconds or an average blinking time for a human eye) indicating that the driver may be dosing off or falling asleep, whether the driver's eyes wander away from the road longer than a pre-defined period (e.g., when the driver looks down at his or her phone, at the radio controls of the vehicle (e.g., the controls for the “infotainment” features of the vehicle), at an event to the left or right of the vehicle, e.g., an accident on the other side of the road, etc.), whether the driver's eyes look both left and right directions before a lane change, and the like.

In one embodiment, the physical attribute monitoring module 110 may monitor physical gestures of the driver and/or how well a driver controls the vehicle 100. For example, the sensors 114 may include an external video camera, one or more touch sensors, lane departure sensors, a vehicle stability sensor, a speedometer, a sensor to monitor G-forces of the vehicle 100, and the like. In one embodiment, the action items within the physical attribute monitoring module may include, for example, the driver's ability to maintain a straight line (e.g., sensors monitoring lane markers on the road), the driver's ability to maintain a constant speed (e.g., sensors deployed in a vehicle that relay speed to the dashboard of a vehicle), the driver's ability to take a turn at a proper speed (sensors monitoring slippage of one or more tires on a turn, or G force during a turn and the like), whether the driver is placing both hands on the steering wheel (e.g., sensors deployed on the steering wheel to measure a resistance or current that can be interpreted as one or more hands (or even no hands) on the steering wheel), and the like.

In one embodiment, the driver responsiveness monitoring module 112 may monitor how well a driver reacts to various driving conditions. For example, the sensors 114 may include: a rain sensor, a brake sensor, and the like. In one embodiment, the action items within the driver responsiveness monitoring module may include, for example, how often a driver suddenly brakes, how often the driver swerves within a driving lane, detecting whether the driver engages a turn signal indicator when turning or changing lanes, how quickly the driver turns on the wiper blades when it begins to rain, how quickly a driver turns on the head lights when low light condition is detected, and the like.

It should be noted that any one of the sensors 114 described above may be accessed by anyone of the monitoring modules 102, 108, 110 and 112. It should be noted that the above list of various sensors 114 are only examples and should not be considered limiting. In addition, the vehicle 100 may include other sensors not described above.

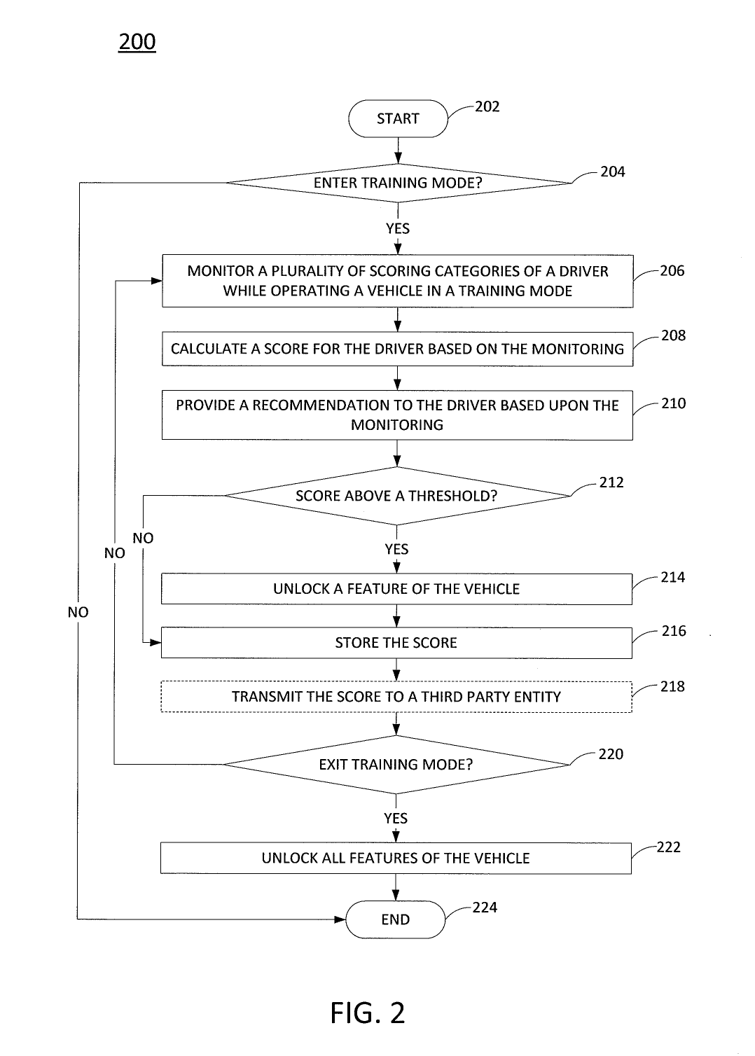

FIG. 2 illustrates a flowchart of a method 200 for providing driver training in a vehicle. In one embodiment, the method 200 may be performed by the CPU 102 of the vehicle 100 or a general purpose computer deployed in the vehicle as illustrated in FIG. 3 and discussed below.

The method 200 begins at step 202. At step 204, the method 200 determines if a training mode is entered. In one embodiment, the training mode may be entered remotely or when a driver enters a vehicle.

For example, when a driver enters a vehicle, the driver may select to enter a training mode. In one embodiment, a driver may enter a pre-defined code or password to enable the training mode for a driver in training. In one embodiment, once the training mode is entered, the training mode may be enabled until the experienced driver enters another pre-defined code or password to disable the training mode. It should be noted that the individual engaging the training mode does not have to be the driver, e.g., a parent may activate the training mode before allowing a child to operate the vehicle.

In another embodiment, the vehicle may automatically detect whether training mode should be entered based upon an identification of the driver. For example, the key or key fob may be programmed or associated with specific drivers. In another embodiment, facial recognition or fingerprinting may be used based upon the camera sensors deployed in the vehicle used to monitor the driver.

If the training mode is not entered, the method 200 may proceed to step 224. The method ends at step 224 and the vehicle may operate or be operated normally. However, if the training mode is entered at step 204, the method 200 may optionally disable all or some features of the vehicle. For example, the features may include “infotainment” features or cabin control features of the vehicle such as for example, input/output ports to connect an external media device (e.g., an Ipod® connector, an aux connector, and the like), a radio, a CD player, Internet access, weather information, temperature setting controls, fan setting controls, and the like. In another embodiment, some features of the vehicle need not be actively disabled, but instead may simply be in a default state where such features are not activated when the vehicle is started. These features can be subsequently activated as discussed below when a certain score is achieved by the driver.

The features may be turned off based upon a scoring level of the driver, as will be discussed below. Once the proper features of the vehicle are disabled the method may proceed to step 206.

At step 206, the method 200 monitors a plurality of scoring categories of a driver while operating the vehicle in the training mode. In one embodiment, the scoring categories may include eye movement of the driver, a physical driving attribute of the driver and a responsiveness of the driver as discussed above. It should be noted that other categories may be monitored and the above examples should not be considered as limiting. Each one of the scoring categories may include action items within the category that are monitored and scored to obtain an overall score.

In one embodiment, the method 200 may track a driver's score for each one of the plurality of scoring categories to baseline and track a driver's progress. If the driver's skill in a particular category is deteriorating, the method 200 may be able to notify the driver of specific skills or a particular category that the driver should practice more often.

In one embodiment, the eye movement of the driver category may include action items, such as for example, whether the eyes are closed longer than a pre-defined period indicating the driver may be dosing off or falling asleep, whether the driver's eyes wander away from the road, i.e., being distracted (e.g., when the driver looks down at his or her phone, at the radio, at a crash on the other side of the road, etc.), whether the driver's eyes look both left and right during a lane change, i.e., whether the driver is being attentive to the task of driving, and the like. In one embodiment, the physical driving attribute category may include action items, such as for example, the driver's ability to maintain a straight line, the driver's ability to maintain a constant speed, the driver's ability to take a turn at a proper speed, whether the driver is placing both hands on the steering wheel, and the like. In one embodiment, the responsiveness of the driver category may include action items, such as for example, how often the driver suddenly brakes, how often the driver swerves within a driving lane, detecting whether the driver engages a turn signal when turning or changing lanes, how quickly the driver turns on the wiper blades when it begins to rain, and the like.

In one embodiment, each one of the plurality of categories and the individual action items within each one of the plurality of categories may be monitored by one or more sensors in the vehicle. For example, the vehicle may include a camera that monitors the driver's eyes. In another embodiment, the vehicle may have an external camera that monitors a driving lane and the vehicles movement relative to the driving lanes to determine swerve, lane drifting, lane changing, turning, etc. In another embodiment, the vehicle may include sensors that sense how hard or soft the vehicle is braking, and the like. Any sensors may be included that are needed to monitor the action item of each one of the plurality of categories. In one embodiment, a combination or a sequence of the individual action items within each one of the plurality of categories may be monitored.

At step 208, the method 200 calculates a score for the driver based on the monitoring. Any scoring system may be used to calculate the score. In one embodiment, the scoring may be cumulative. For example, each time an action item of one of the plurality of categories is performed (e.g., checking blind spots during a lane change) or maintained (e.g., driving straight without drifting in a lane for 10 miles) a point may be awarded to the driver.

In another embodiment, the scoring may be a deduction system. For example, the driver may begin with 100 points. For each action item of the plurality of categories is violated or not maintained, a point may be deducted.

At step 210, the method 200 may provide a recommendation to the driver based upon the monitoring. In one embodiment, the recommendation is provided immediately in response to the monitoring and detection of a low scoring event. A low scoring event is broadly defined as an event that caused a significant drop in the driver's score due to a dangerous action taken by the driver. For example, if the driver is turning and failed to turn on a turn signal indicator, the vehicle may immediately turn on the proper turn signal for the driver. In another embodiment, if the driver is drifting out of his or her lane and the driver's eyes are detected as being closed for an unacceptable period of time, the vehicle may provide haptic feedback on the steering wheel and provide a slight nudge to the driver's hand in the appropriate direction. In another embodiment, an audio and/or video cue may be provided to the driver in response to a driver's action during the monitoring if immediate recommendations are needed.

In one embodiment, the recommendation may be provided as a prediction based upon the monitoring. For example, if the vehicle senses that the car is slowing down and approaching an intersection the method 200 may predict the driver may be turning and provide a recommendation to turn on a turn signal. In another embodiment, the vehicle may detect the user has a turn signal on and is moving at a constant speed. The method 200 may predict that the driver is about to change lanes and provide a recommendation to look at the driver's blind spots before changing lanes. Other predictive recommendations may be evident based upon the examples provided above.

In another embodiment, the recommendation may be provided once the driver turns off the ignition for the vehicle. For example, when the driver is done driving, the vehicle may provide suggestions on areas of improvement for one or more of the action items in one or more of the plurality of categories. For example, the recommendation may include a suggestion to practice a particular driving skill, e.g., looking left and right before changing lane, using turn signals before making turns, staying in the middle of the lane to reduce drifting of the vehicle, reducing speed when entering a curve, and so on. As discussed above, the recommendation may include areas to practice more often based upon a deteriorating score or downward trending baseline for a particular skill or category used for scoring. In one embodiment, the recommendation may be displayed on a graphical user interface of the vehicle. In one embodiment, the recommendation may be emailed or text messaged to the driver via a wireless communication module.

At step 212, the method 200 may determine if the driver's score is above a predefined threshold. As the driver continues to train and improve his or her driving ability, the driver may accumulate a higher score. If a scoring threshold is reached, one or more features of the vehicle may be re-enabled. For example, as discussed above, the features may include “infotainment” features of the vehicle such as for example, input/output ports to connect an external media device (e.g., an Ipod® connector, an aux connector, and the like), a radio, a CD player, Internet access, weather information, and the like. In other words, the driver has scored sufficiently high to be allowed to activate various controls of the cabin of the vehicle while the vehicle is in motion, e.g., above 30 miles per hour and the like. Thus, a driver is rewarded with the ability to enjoy certain features (e.g., existing features or new features if the vehicle is updated with new features or software) of the vehicle once the driver has demonstrated his or her competence to safely operate the vehicle.

In one embodiment, the one or more features may be divided into different groups of features that are associated with different scoring levels each having a respective threshold. For example, low distraction scoring level features such as voice control, air condition/heat controls may have a low scoring threshold. Medium distraction scoring level features, such as for example, radio controls and global positioning system (GPS) may have a medium scoring threshold. High distraction scoring level features, such as for example, Internet searching, video systems, input/outputs for external media devices, telephony communications and the like, may have a high scoring threshold. The grouping of features described above is provided as one example and should not be considered limiting. The features may be organized in any manner to define the different scoring levels.

If the driver's score is above a threshold, the method 200 may proceed to step 214. At step 214, the method 200 may unlock or re-enable a feature of the vehicle. As discussed above, the threshold may include a summation of different scoring level thresholds. In one embodiment, one or more features may be enabled based upon a scoring level that is achieved by the driver. The method 200 then proceeds to, step 216.

However, at step 212 if the driver's score is not above a threshold, then the method 200 may proceed to step 216. At step 216, the method 200 stores the score of the driver.

At optional step 218, the method 200 may transmit the score to a third party entity. In one embodiment, the third party entity may be an automobile insurance company. For example, the insurance company may agree to lower insurance rates for drivers that reach a particular score in the training mode. In another embodiment, the insurance rate may change dynamically based upon the driver's score in the training mode. For example, the insurance rate or premium of the driver may go up or down as the driver's score goes up or down during a particular time period, e.g., monthly, quarterly, yearly and so on.

At step 220, the method 200 determines if the training mode should be exited. For example, the driver may have successfully completed his or her training. In another embodiment, a more experienced driver may wish to drive the vehicle and enter a pre-defined code or password to exit the training mode. If the training mode is not exited, the method 200 may return to step 206 to continue monitoring and various steps of the method 200 may be repeated.

However, at optional step 220 if the training mode is exited, the method 200 may proceed to step 222. At step 222, all features of the vehicle are unlocked. The method 200 then ends at step 224.

It should be noted that although not explicitly specified, one or more steps or operations of the method 200 described above may include a storing, displaying and/or outputting step as required for a particular application. In other words, any data, records, fields, and/or intermediate results discussed in the methods can be stored, displayed, and/or outputted to another device as required for a particular application. Furthermore, steps, operations or blocks in FIG. 2 that recite a determining operation, or involve a decision, do not necessarily require that both branches of the determining operation be practiced. In other words, one of the branches of the determining operation can be deemed as an optional step.

FIG. 3 depicts a high-level block diagram of a general-purpose computer suitable for use in performing the functions described herein. As depicted in FIG. 3, the system 300 comprises one or more hardware processor elements 302 (e.g., a central processing unit (CPU), a microprocessor, or a multi-core processor), a memory 304, e.g., random access memory (RAM) and/or read only memory (ROM), a module 305 for providing driver training in a vehicle, and various input/output devices 306 (e.g., storage devices, including but not limited to, a tape drive, a floppy drive, a hard disk drive or a compact disk drive, a receiver, a transmitter, a speaker, a display, a speech synthesizer, an output port, an input port and a user input device (such as a keyboard, a keypad, a mouse, a microphone and the like)). Although only one processor element is shown, it should be noted that the general-purpose computer may employ a plurality of processor elements. Furthermore, although only one general-purpose computer is shown in the figure, if the method(s) as discussed above is implemented in a distributed or parallel manner for a particular illustrative example, i.e., the steps of the above method(s) or the entire method(s) are implemented across multiple or parallel general-purpose computers, then the general-purpose computer of this figure is intended to represent each of those multiple general-purpose computers. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented.

It should be noted that the present disclosure can be implemented in software and/or in a combination of software and hardware, e.g., using application specific integrated circuits (ASIC), a programmable gate array (PGA) including a Field PGA, or a state machine deployed on a hardware device, a general purpose computer or any other hardware equivalents, e.g., computer readable instructions pertaining to the method(s) discussed above can be used to configure a hardware processor to perform the steps, functions and/or operations of the above disclosed methods. In one embodiment, instructions and data for the present module or process 305 for providing driver training in a vehicle (e.g., a software program comprising computer-executable instructions) can be loaded into memory 304 and executed by hardware processor element 302 to implement the steps, functions or operations as discussed above in connection with the exemplary method 200. Furthermore, when a hardware processor executes instructions to perform “operations”, this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 305 for providing driver training in a vehicle (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. More specifically, the computer-readable storage device may comprise any physical devices that provide the ability to store information such as data and/or instructions to be accessed by a processor or a computing device such as a computer or an application server.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method for providing a recommendation in a vehicle, comprising:
monitoring, by a processor, a plurality of scoring categories of a driver while the vehicle is operating in a training mode;
calculating, by the processor, a score for the driver based on the monitoring of the plurality of scoring categories; and
providing, by the processor, the recommendation to the driver based upon the monitoring of the plurality of scoring categories.

2. The method of claim 1, further comprising:
unlocking, by the processor, a feature of the vehicle when the score is above a threshold.

3. The method of claim 1, wherein a plurality of features is divided into a plurality of different scoring levels with each scoring level having a respective threshold and a group of features of the plurality of features in a scoring level is unlocked when the score is above the respective threshold.

4. The method of claim 1, further comprising:
storing, by the processor, the score for the driver; and
transmitting, by the processor, the score to a third party entity.

5. The method of claim 4, wherein the third party entity comprises an automobile insurance company.

6. The method of claim 1, wherein one of the plurality of scoring categories comprises an eye movement of the driver.

7. The method of claim 1, wherein one of the plurality of scoring categories comprises a physical driving attribute of the driver.

8. The method of claim 1, wherein one of the plurality of scoring categories comprises a responsiveness of the driver.

9. The method of claim 1, wherein the recommendation comprises a haptic feedback in response to a low scoring event that is detected.

10. The method of claim 1, wherein the recommendation comprises a suggestion to practice a particular driving skill.

11. The method of claim 1, further comprising:
exiting, by the processor, the training mode of the vehicle; and
unlocking, by the processor, all features of the vehicle.

12. A computer-readable storage device storing a plurality of instructions which, when executed by a processor, cause the processor to perform operations for providing a recommendation in a vehicle, the operations comprising:
monitoring a plurality of scoring categories of a driver while the vehicle is operating in a training mode;
calculating a score for the driver based on the monitoring of the plurality of scoring categories; and
providing the recommendation to the driver based upon the monitoring of the plurality of scoring categories.

13. The computer-readable storage device of claim 12, further comprising:
unlocking a feature of the vehicle when the score is above a threshold.

14. The computer-readable storage device of claim 12, wherein a plurality of features is divided into a plurality of different scoring levels with each scoring level having a respective threshold and a group of features of the plurality of features in a scoring level is unlocked when the score is above the respective threshold.

15. The computer-readable storage device of claim 12, further comprising:
storing the score for the driver; and
transmitting the score to a third party entity.

16. The computer-readable storage device of claim 15, wherein the third party entity comprises an automobile insurance company.

17. The computer-readable storage device of claim 12, wherein one of the plurality of scoring categories comprises an eye movement of the driver.

18. The computer-readable storage device of claim 12, wherein one of the plurality of scoring categories comprises a physical driving attribute of the driver.

19. The computer-readable storage device of claim 12, further comprising:
exiting the training mode of the vehicle; and
unlocking all features of the vehicle.

20. An apparatus for providing a recommendation in a vehicle, comprising:
a processor; and
a computer-readable storage device storing a plurality of instructions which, when executed by the processor, cause the processor to perform operations, the operations comprising:
monitoring a plurality of scoring categories of a driver while the vehicle is operating in a training mode;
calculating a score for the driver based on the monitoring of the plurality of scoring categories; and
providing the recommendation to the driver based upon the monitoring of the plurality of scoring categories.
